(19) United States
(12) Patent Application Publication
(10) Pub. No.: US 2004/0117606 A1
(43) Pub. Date: Jun. 17, 2004

(54) Method and apparatus for dynamically conditioning statically produced load speculation and prefetches using runtime information

(76) Inventors: Hong Wang, Fremont, CA (US); Rakesh Ghiya, Santa Clara, CA (US); John P. Shen, San Jose, CA (US); Ed Grochowski, San Jose, CA (US); Jim Fung, San Jose, CA (US); David Sehr, Cupertino, CA (US); Kevin Rudd, Portland, OR (US)

Correspondence Address: John P. Ward, Blakely, Sokoloff, Taylor & Zafman LLP, Seventh Floor, 12400 Wilshire Boulevard, Los Angeles, CA, 90025-1030, US

(21) Appl. No.: 10/323,989

(22) Filed: Dec. 17, 2002

(51) Int. Cl. G06F 9/00

(52) U.S. Cl. 712/235

(57) ABSTRACT

The invention provides a method comprising monitoring an indicator indicating a usage of data speculatively loaded by a processor as a result of executing a speculative instruction; and selectively executing said speculative instruction when it is next encountered as an instruction pointer based on said usage. According to another embodiment, the invention provides a processor comprising a monitoring mechanism to monitor an indicator indicating a usage of data speculative loaded by said processor as a result of executing a speculative instruction; and a speculation control mechanism to selectively execute said speculative instruction when it is next encountered at an instruction pointer based on said usage.

### FIELD OF THE INVENTION

This invention relates to data processing. In particular it relates to control speculation and to data prefetching in a high performance processor.

### BACKGROUND

In order to improve computational throughput in a high performance processor, compilers generally make certain optimizations when compiling high-level code into machine code so that a pipeline of the processor is kept busy. Once such optimization in known as control speculation. The basic idea of control speculation is to vary the order in which instructions are executed so that while data is being accessed from memory, the pipeline is kept busy with the processing of other instructions. In particular, load instructions occurring within a branch in a program are hoisted by a compiler above the branch thus allowing other instructions in the program to be executed while the load instruction is being executed. These hoisted load instructions are known as speculative-load instructions because it is not known whether data loaded into the processor as a result of executing these load instructions will get to be used. Usage of said data is dependent on whether the branch where the original load instruction occurred is taken during program execution.

Because control speculation loads data speculatively into a processor before using the data, a validation of the data must first be performed. Compilers which perform control speculation force such validation to be performed by leaving a validation instruction sequence in the optimized code immediately before any use of speculatively loaded data.

Prefetching is another technique used to optimize computational throughput. With prefetching, a block of data is brought from random-access memory (RAM) into a data cache before it is actually referenced. During code optimization a compiler tries to identify a data block needed in future and, using prefetch instructions, may cause the memory hierarchy associated with the processor to move the block into a data cache. When the block is actually referenced, it may then be found in the data cache, rather than having to be fetched from RAM, thus improving computational throughput.

Both control speculation and prefetching represent compiler generated hints that are assumed to be correct. Thus with a control-speculation instruction, fetching begins in the predicted direction. If the speculation turns out to be wrong and a fault occurs during execution of a speculative load instruction, then the fault will be recorded and the handling thereof will be deferred to when the corresponding check instruction detects the fault and activates appropriate recovery code. Executing recovery code can cause the pipeline to stall thereby reducing computational throughput.

One problem with compiler generated speculative-load and prefetch instructions is that these instructions are statically generated at compile-time and cannot be dynamically conditioned at runtime and so it may turn out that a speculative-load or prefetch instruction loads data into the processor that does not get referenced. If this situation arises then computational throughput suffers. Moreover, there is a penalty to pay in the case of the prefetch. This penalty is the opportunity cost of not having space in the data cache for data that does get referenced later. This behavior may be a problem as a data cache is of limited size and therefore care should be taken that it should be populated with data that actually will likely get referenced.

### BRIEF DESCRIPTION OF THE DRAWINGS

FIG. 1 shows a schematic drawing of program flow in a program before control speculation;

FIG. 2 shows a schematic drawing of program flow in the program of FIG. 1 after control speculation;

FIG. 3 shows a portion of a program which includes speculative instructions generated by a compiler;

FIG. 4 shows a table of the instructions actually executed during several iterations of the program of FIG. 3;

FIG. 5A shows a mapping table in accordance with one embodiment of the invention;

FIG. 5B shows the mapping table of FIG. 5A in which the usage prediction is set to false;

FIG. 6 shows a mapping table in accordance with another embodiment of the invention;

FIG. 7 shows a flowchart of operations performed in one embodiment of the invention in predicting a usage of data to be loaded as a result of executing a speculative instruction;

FIGS. 8, 9 and 10 show aspects of operations shown in FIG. 7 in greater detail;

FIG. 11 shows a processor in accordance with one embodiment of the invention; and

FIG. 12 shows a usage predictor forming part of the processor of FIG. 11 in greater detail.

### DETAILED DESCRIPTION

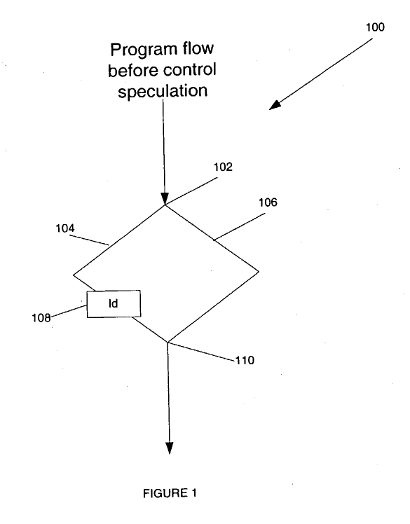

FIG. 1 of the drawings shows program flow in a portion of a program 100 before control speculation. In FIG. 1, reference numeral 102 indicates a branch entry point, reference numeral 104 indicates a left branch which would typically include a series of instructions which are executed if left branch 104 is taken after branch entry point 102 is encountered during program execution. Reference numeral 106 indicates a right branch which likewise has a number of instructions which are executed if right branch 106 is taken after branch entry point 102 is encountered during program execution. One instruction occurring on left branch 104 includes a load instruction (ld) indicated by reference numeral 108. Reference numeral 110 indicates a branch exit point.

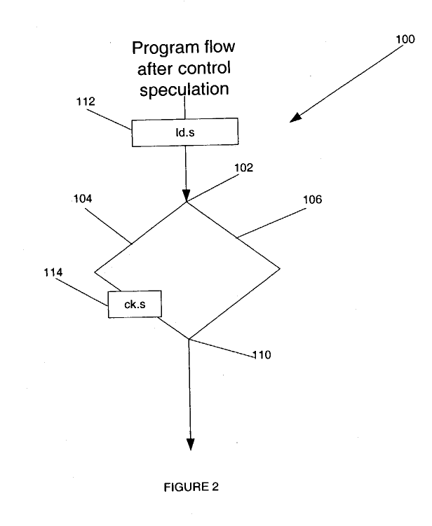

FIG. 2 of the drawings shows program flow in program 100 after a compiler has performed control speculation. Referring to FIG. 2 it will be noted that the load instruction 108 has been replaced by a speculative-load instruction (ld.s) 112 which has been placed above branch entry point 102. During compilation of program 100, a speculation-check instruction (chk.s) 114 is left at the point where the load instruction (ld) 108 occurred on left branch 104. Thus, it will be seen that control speculation results in a speculative-load (ld.s) instruction 112 being performed early during program execution thus allowing a processor to process a maximum number of instructions without stalling. In the event of the branch 104 being taken then the speculation-check instruction (chk.s) 114 is performed in order to validate the speculatively loaded data before it is used.

One problem with control speculation as illustrated in FIG. 2 of the drawings is that the speculative-load instruction (ld.s) and the speculation-check instruction (chk.s) are statically generated by compiler. It may turn out that during actual program execution data loaded into a register of a processor as a result of executing the compiler generated speculative-load instruction (ld.s) does not actually get used or referenced. If this situation arises then computational throughput may be reduced because of overhead from having to load data speculatively into a register and then not use it.

Another example of a compiler generated speculative instruction is a prefetch instruction which prefetches data into a data cache so that when said data is referenced it can be loaded into a pipeline of a processor much faster than if it were to be retrieved from memory. Prefetch instructions represent a compiler's best guess as to which data is likely to get referenced. As with speculative loads it may turn out that a compiler is wrong and the prefetched data does not get used. In this case there may be a penalty of having to prefetch and store data in valuable cache memory space and then not use the data.

According to one embodiment, the present invention provides a mechanism to determine whether data which is speculatively loaded by a processor as a result of executing a speculative instruction actually gets used. A history of a usage of the data is maintained and prediction algorithms are used to predict whether the data is likely to be used based on the history. The prediction is then used to dynamically control whether to execute the speculative instruction when it is next encountered so that the speculative instruction is only executed when the data to be loaded by executing the speculative instruction is predicted to be used. The speculative instruction is statically produced by a compiler and may be a speculative-load instruction (ld.s) or a prefetch instruction. Usage of data speculatively loaded by a processor is determined by monitoring an indicator of such usage. In the case of a speculative-load instruction (ld.s) an indicator of said usage may be an execution of a speculation-check instruction (chk.s), which verifies that the data is valid before it is used or the execution of another load instruction (ld) which overwrites data loaded speculatively into the processor before that data gets used. This situation is typically known as a write-after-write condition. In the case of the speculative instruction being a prefetch instruction, the usage indicator that is monitored is the execution of a load instruction which loads the prefetched data from cache memory into a pipeline of the processor, thus indicating that the data actually gets used.

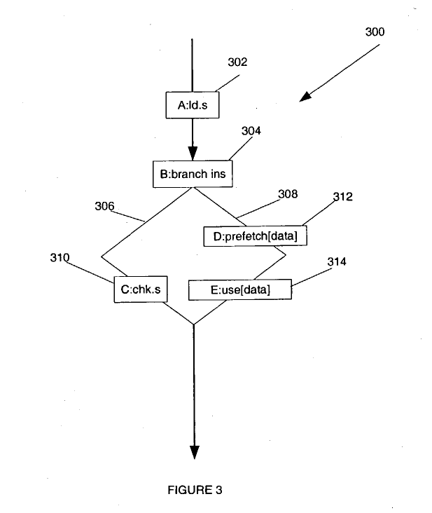

FIG. 3 of the drawings shows a portion of a program 300 which will be used to describe the present invention. Program 300 includes a speculative-load instruction (ld.s) 302 at instruction pointer A and a branch instruction 304 at instruction pointer B. The branch instruction 304 guards entry to a branch comprising a left branch 306 and a right branch 308. A speculation-check instruction (chk.s) 310 occurs on the left branch 306 at instruction pointer C and a prefetch instruction 312 occurs on the right branch 308 at instruction pointer D. Also occurring on the right branch 308 is a use instruction 314 which occurs at instruction point E and which when executed causes data prefetched by prefetch instruction 312 to be used.

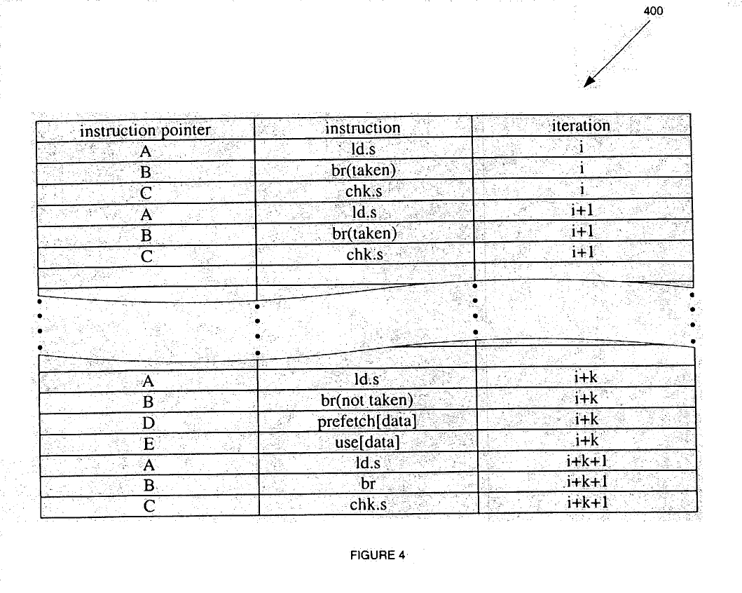

Referring now to FIG. 4 of the drawings, reference numeral 400 generally indicates a table which traces several iterations of program 300. It will be seen that during iterations i, i+1 and i+k+1 left branch 306 gets taken whereas during iteration i+k right branch 308 gets taken.

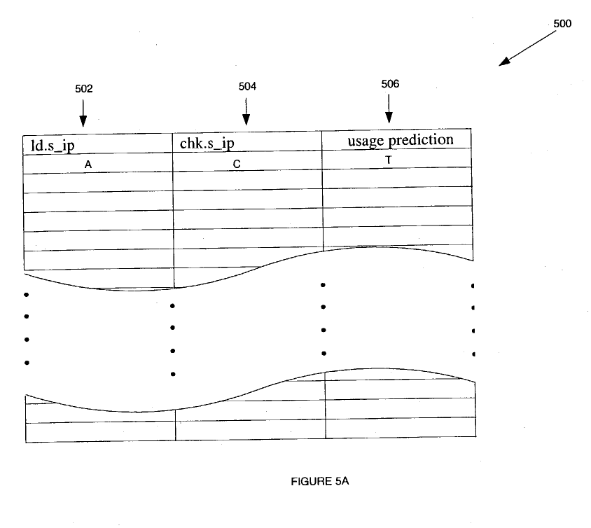

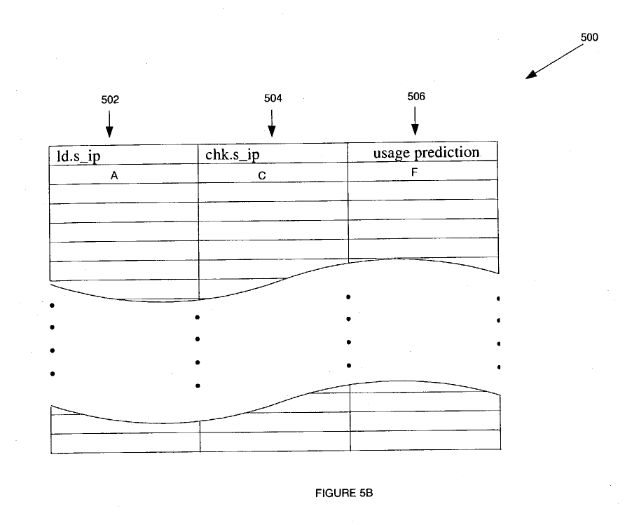

Ordinarily, when the instructions ld.s and prefetch in program 300 are encountered at an instruction pointer, they are automatically executed. However, in accordance with embodiments of the present invention described below these instructions will only be executed if it is predicted that data to be loaded into a processor by executing these instructions would be used. Thus, according to one embodiment of the invention, a table such as the one indicated generally by reference numeral 500 in FIG. 5A of the drawings is used to condition the execution of these speculative instructions as will be explained below. Table 500 includes a column 502 which contains the instruction pointer for each speculative-load instruction (ld.s) occurring in program 300 and a column 504 which contains the instruction pointer for the speculation-check instructions (chk.s) associated with each speculative-load instruction (ld.s). The entry shown in column 502 and 504 indicates that at instruction pointer A there is a speculative-load instruction (ld.s) which is associated with a speculation-check instruction (chk.s) occurring at instruction pointer C. Thus, columns 502 and 504 of Table 500 represent a mapping between each speculative-load instruction (ld.s) and its associated check instruction (chk.s) in program 300. Table 500 also includes a column 506 which represents a usage prediction as to whether data to be loaded into a processor as a result of executing the speculative-load instruction (ld.s) will be used or not. In the case of the entry shown in Table 500, the usage prediction indicates that the data to be speculatively loaded will be used. During program execution, whenever the processor detects that a usage prediction associated with a particular speculative-load instruction (ld.s) is predicted as true, then the processor will execute the speculative-load instruction (ld.s). On the other hand, if the processor detects that that the usage prediction is false then the processor will not execute the speculative-load instruction (ld.s). The mechanism for determining what value to assign to column 506 is described in greater detail in the following paragraphs and is based on a usage of data speculatively loaded by the speculative instruction under consideration, during previous iterations.

When the processor determines not to execute the speculative-load instruction upon prediction of no-use, the processor is responsible for marking a deferrable fault condition in the destination register of the speculative-load instruction (ld.s). For example, on Itanium architecture, this is equivalent to turning on the NAT (not-a-thing) bit of the destination register. Should the prediction be a wrong prediction, i.e., there is actually a use of the data that was to be loaded by the speculative-load, a check or verification instruction (chk.s) will be able to detect the deferred fault condition (i.e. the NAT value) and activate recovery code to perform a load of the data.

FIG. 5B of the drawings shows an update of table 500 during iteration i+k+1 of Table 400 in FIG. 4. It will be noted that column 506 of FIG. 5B has a value of “false.” Therefore during iteration i+k+1 the speculative-load instruction (ld.s) at instruction pointer A will not be executed.

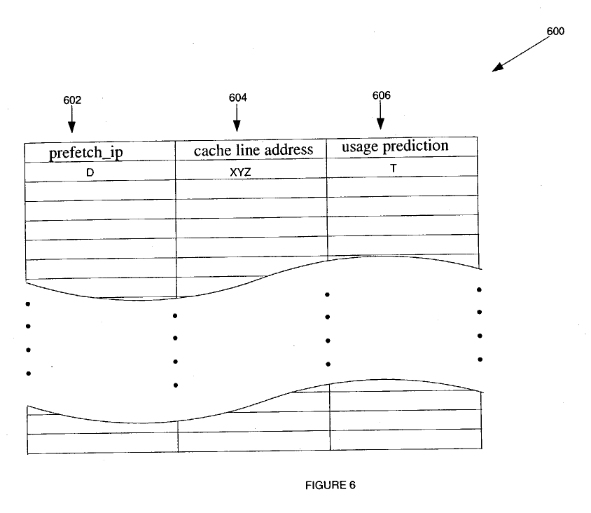

FIG. 6 of the drawings shows a Table 600 which is generated in accordance with another embodiment of the invention for each prefetch instruction within program 300 and is similar to Table 500. Table 600 includes columns 602 and 604 which provide a mapping between the instruction pointer of each prefetch instruction and a cache-line address at which data which was prefetched by executing the prefetch instruction was stored. Table 600 also includes column 606 which represents a usage prediction as to whether the data to be prefetched as a result of executing a prefetch instruction will be used or not.

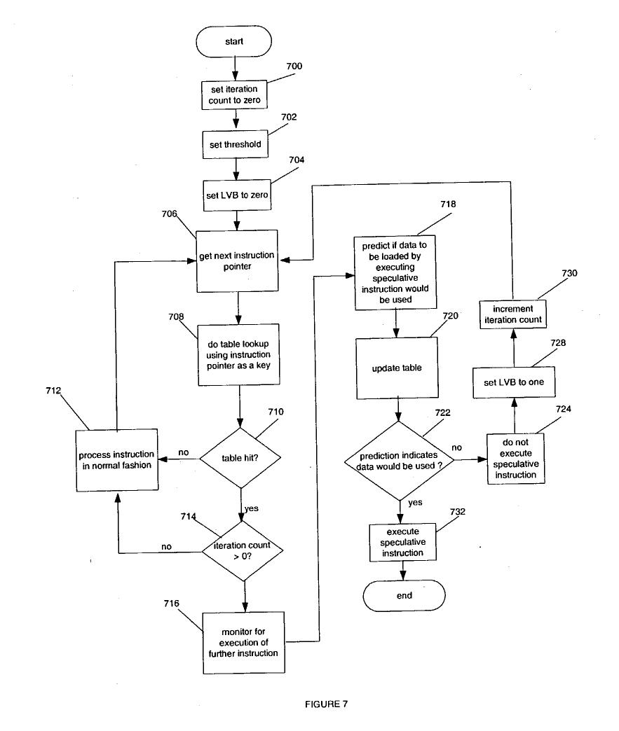

Predicting usage involves monitoring an indicator which indicates usage of data speculatively loaded into the processor as a result of executing a speculative instruction. In the case of the speculative instruction being a speculative-load instruction (ld.s) the indicator may be a validation instruction in the form of a speculation-check instruction (chk.s). Since the speculation-check instruction (chk.s) is not executed unless data previously loaded by a speculative-load instruction (ld.s) associated with the speculation-check instruction is actually going to be used, monitoring for the execution of a (chk.s) instruction provides an indication that the data is actually used. Another indicator of data usage in the case of a speculative-load instruction (ld.s) is the execution of another load instruction which overwrites data loaded as a result of executing the speculative-load instruction (ld.s). For example, suppose the speculative-load instruction (ld.s) being monitored loads a value into a Register 12 but before execution of a speculation-check instruction (chk.s) associated with the speculative-load (ld.s) instruction, another load instruction is executed which loads another value into Register 12. If this occurs then it would indicate that the value loaded into Register 12 as a result of executing the speculative-load instruction never gets used. One mechanism that may be used to track usage of data loaded into a processor by the execution of a speculative-load instruction (ld.s) as discussed above includes the implementation of a last validation bit (LVB) and a history of validation (HOV). The purpose of LVB and HOV will become apparent from a description of the method shown in FIG. 7 of the drawings.

FIG. 7 of the drawings shows a flow chart of the operations performed in executing program 300 in accordance with one embodiment of the invention. Referring to FIG. 7 at block 700 an iteration counter which counts each iteration of program 300 is initially set to zero. At block 702 a threshold N is set to a number which represents the number of consecutive executions of a speculative instruction which loads data into the processor and which data does not get used. For example, if this number is set to 3, an algorithm used to predict usage of data speculatively loaded into the processor will allow 3 executions of the speculative instruction being monitored to proceed before toggling the usage prediction value to false. At block 704 the LVB is set to zero and the next instruction pointer is obtained at block 706. This instruction pointer is used as a key to perform a lookup of a mapping table (such as the one shown in FIGS. 5A, 5B and 6 of the drawings) at block 708.

In one embodiment, the mapping table is generated by a compiler and is loaded into an electronic hardware structure in the processor at runtime as described below.

At block 710 a test is performed to determine whether a table hit is generated which would indicate that the instruction pointer points to a speculative instruction, which may be a speculative-load instruction (ld.s) or a prefetch instruction. If no table hit is generated then at block 712 the instruction is processed in normal fashion whereafter the next instruction pointer is obtained at block 706. If, on the other hand, a table hit is generated then at block 714 a test is performed to check if the iteration count is greater than zero. If the iteration count is not greater than zero then block 712 is performed, otherwise, block 716 is performed, which includes monitoring for the execution of a further instruction, which would indicate that data loaded on the last iteration as a result of executing the speculative instruction being monitored actually gets used. It will be appreciated that the test at block 714 ensures that if the iteration count is zero which would indicate a first pass through program 300, then the speculative instruction at the instruction pointer will always be executed and only on the second and subsequent iterations, when there is a history of the usage of data speculatively loaded into the processor as a result of executing the speculative instruction being monitored, will program execution proceed to block 716. The further instruction whose execution is being monitored may include the execution of a speculation-check instruction (chk.s) in the case of the speculative instruction being a speculative-load instruction (ld.s) or the execution of a load instruction (ld) which overwrites data speculatively loaded as a result of the execution of the speculative-load instruction (ld.s) before use of that data. In another embodiment, and in the case of the speculative instruction being a prefetch instruction, the further instruction is the execution of an instruction which actually uses data loaded into cache memory as a result of executing the prefetch instruction being monitored. The specific steps that are performed in executing block 716 will be described in greater detail below. After execution of block 716, block 718 is executed which includes updating the mapping table. At block 720 a prediction is made as to whether data to be loaded by executing the speculative instruction would be used. At block 722 the mapping table is read to determine what prediction value has been assigned to the speculative instruction being monitored. If the prediction value is false then the speculative instruction is not executed as indicated by block 724, at block 728 the LVB is set to one, the iteration counter is incremented by one at block 730, and block 706 is performed again. If on the other hand, the prediction value is set to true than the speculative instruction is executed at block 732 whereafter the process ends.

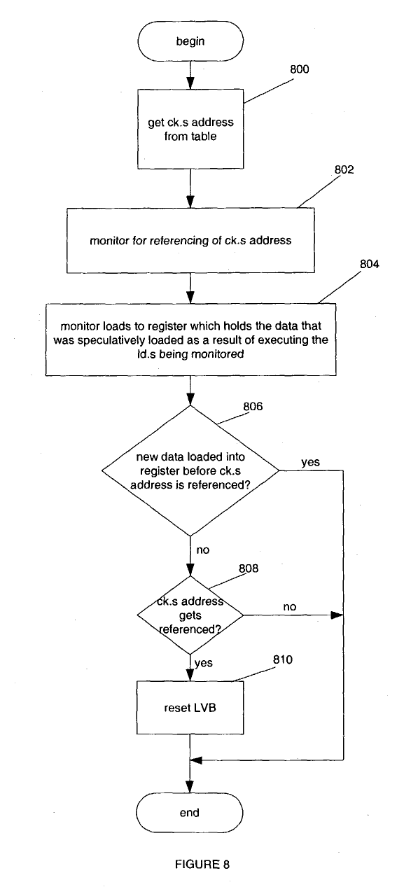

FIG. 8 of the drawings shows a flow chart of operations performed in executing block 716 of FIG. 7 in the case of the speculative-load instruction being monitored being a speculative-load instruction (ld.s). Referring to FIG. 8 at block 800 the address of the speculation-check instruction (chk.s) is obtained from the mapping table. At block 802 program execution is monitored for any reference to the address of the speculation-check instruction (chk.s). At block 804 program execution is monitored for any load to the register which holds the data that was speculatively loaded as a result of executing the speculative-load instruction (ld.s) being monitored. A determination is made at block 806 as to whether any new data was loaded into said register before the address of the speculation-check instruction (chk.s) is referenced. If it turns out that such new data was loaded, which would indicate that there was no use of the speculatively loaded data in said request, then block 716 is ended. If no new data is loaded then block 808 is executed. In block 808 a determination is made as to whether the address of the speculation-check instruction (chk.s) gets referenced during program execution. If there is no reference to the address of the speculation-check instruction (chk.s) then the monitoring at 716 is complete, otherwise at block 810 the LVB value is reset.

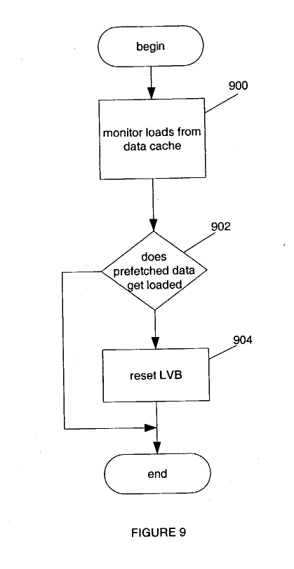

FIG. 9 of the drawings shows a flow chart of operations performed in executing block 716 in FIG. 7 of the drawings in the case of the speculative instruction being monitored being a prefetch instruction. Referring to FIG. 9, at block 900 all loads from the data cache in which the prefetched data was stored is monitored. At block 902 a determination is made as to whether the prefetched data in the data cache is actually loaded into a register of the processor. This is done by monitoring the cache line address which holds the prefetched data. If the prefetch data is not loaded block 716 is complete, otherwise block 904 is performed wherein the LVB value is reset.

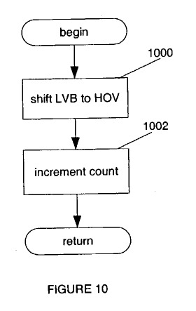

Referring to FIG. 10 of the drawings, the particular operations performed in executing block 718 in FIG. 7 of the drawings is shown. At block 1000 the LVB value is shifted into a data structure which holds the HOV value. Typically, the structures used to implement the LVB and HOV are registers. Thereafter, block 1002 is performed wherein the count is incremented by one.

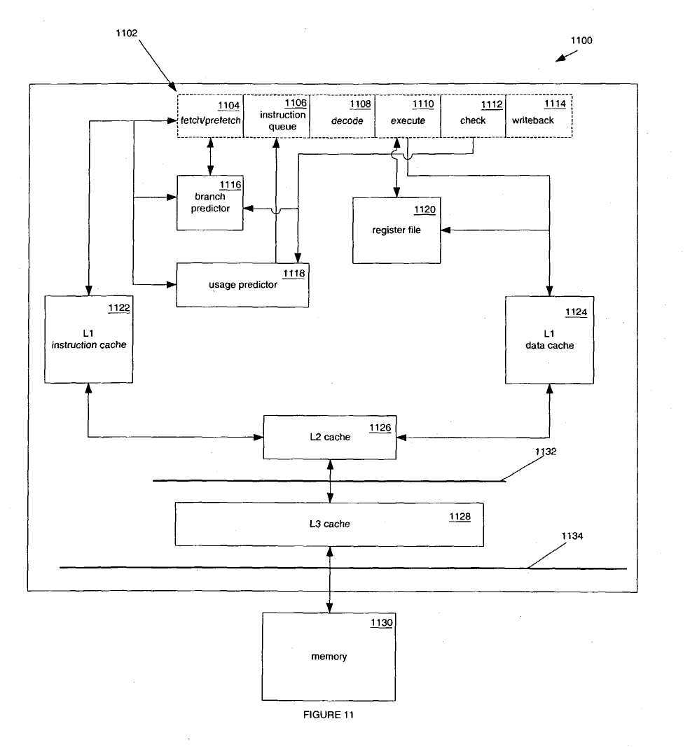

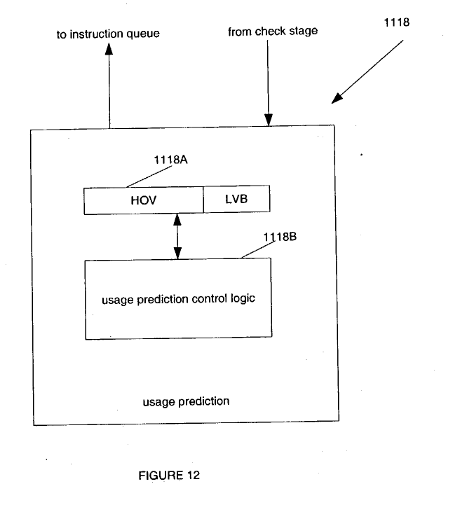

Referring to FIG. 11 of the drawings, reference numeral 1100 indicates a processor in accordance with one embodiment of the invention. The processor 11 includes a pipeline 1102 which is illustrated in dashed lines. The stages of the pipeline 1102 include a fetch/prefetch stage 1104, an instruction queuing stage 1106, a decode stage 1108, an execute stage 1110, a check/error detect stage 1112 and a writeback stage 1114. Each stage executes in a single clock cycle. The above stages are the stages implemented in the preferred embodiment which is described in greater detail below. In other embodiments, the number, or the name of the stages may vary. Furthermore, in the preferred embodiment, the architecture is a superscalar architecture. Thus, each stage may be able to process two or more instructions simultaneously. In the preferred embodiment two parallel paths are provided for each stage so that there is a dual fetch/prefetch stage, a dual instruction queuing stage, dual decode stage, a dual execution stage, a dual check/error detect stage and a dual writeback stage. In other embodiments more than two parallel paths may be provided for each stage. For ease of description, the following description of FIG. 11 assumes a single pipeline. Processor 1100 includes a branch predictor 1116 which includes dynamic branch prediction logic for predicting whether a branch will be taken or not taken. In use, the fetch/prefetch stage 1104 submits the address of a branch instruction to branch predictor 1116 for a lookup and, if a hit results, a prediction is made on whether or not the branch will be taken when the branch instruction is finally executed in the execution stage 1110. Branch predictor 1116 only makes predictions in branches that it has seen previously. Based on this prediction, the branch prediction logic takes one of two actions. Firstly, if a branch is predicted taken, the instructions which were fetched from memory location along the fall-through path of execution are flushed from the block of code that is currently in the fetch/prefetch stage 1104. The branch prediction logic of branch predictor 1116 provides a branch target address to the fetch/prefetch stage 1104 which then prefetches instructions from the predicted path. Alternatively, if a branch is predicted as not taken, the branch prediction logic of branch predictor of 1116 does not flush instructions that come after the branch in the code block currently in the fetch/prefetch stage 1104. Thus, the prefetch stage continues fetching code along the fall-through path. Processor 1100 further includes a usage predictor 1118. The usage predictor 1118 is shown in greater detail in FIG. 12 of the drawings and includes an electronic hardware structure which implements a mapping table such as is shown in FIGS. 5A, 5B and 6 of the drawings. The mapping table is generated by a compiler and loaded into the electronic hardware structure at runtime. Further, the usage predictor 1118 includes usage prediction logic 1118A which includes algorithms to do usage prediction. These algorithms may be similar to traditional branch prediction algorithms. Usage predictor 1118 includes register 1118B which store values for the LVB and HOV. The usage predictor 1118 receives input from the check/error detect stage 1112 which provides information on whether the data speculatively loaded into the processor is actually used. The usage prediction logic 1118A sets a usage prediction bit for each speculative instruction in instruction queue 1106 based on the usage prediction for that instruction. For example, if the usage prediction for a particular speculative instruction is true, then the prediction bit for that instruction is set to one, otherwise the prediction bit is set to zero. Each instruction and its associated prediction bit travels down the pipeline, and each subsequent stage includes first reading the prediction bit and performing substantive operations only if the prediction bit is one, otherwise the instructions simply flows down the pipeline without affecting the processor's state. Thus, an instruction having a prediction bit set to true will not be decoded in the decode stage 1108 or executed during the execute stage 1110. Likewise such an instruction will simply pass through the check/error detect stage 1112 and the writeback stage 1114 without altering the processor's state. The processor 1100 includes a register file 1120 and during execution of an instruction in the execution stage 1110 values are written and read from register file 1120. As discussed above, the check/error detect stage 1112 detects whether the correct instruction was executed in the execute stage 1110 and only if the correct instruction was executed will the processor state be allowed to change in the write back stage 1114. Processor 1100 further includes a cache memory hierarchy comprising a Level 1 instruction cache 1122, a Level 1 data cache 1124, a Level 2 cache 1126 and a Level 3 cache 1128. The Level 2 cache 1126 is connected to the Level 3 cache 1128 via a cache bus 1132. Processor 1100 is also connected to both read-write and read-only memory 1130 via a system bus 1134.

In the embodiment described above, a compiler is used to generate the mapping between speculative-load and its associated verification (chk) instruction. In another embodiment, the mapping may be established speculatively and at runtime in a dynamic manner and without the use of a compiler.

For most compilers that produce speculative-load and corresponding verification instructions, the same register is usually used for the destination operand of each speculative-load instruction and for the source operand of each mathing verification (chk) instruction, even though architecturally, the pair of speculative-load and corresponding verification (chk) instruction do not need to use the same register.

Based on the above observation, in one embodiment, another hardware table is used to speculatively detect pairs of speculative-load and chk instructions based on matching register operands. This approach is dynamic in the sense that it occurs at runtime as opposed to at compile-time. The organization of the table is similar to that of a traditional renaming table. The table is indexed by register ID and implements a mapping from register ID-to-speculative-load instruction pointer-to-chk instruction pointer. A table entry is allocated when a speculative-load is first encountered. The instruction pointer of the first chk instruction that uses the same register ID as the destination of the speculative-load is paired with the speculative-load, thus establishing a mapping, which can be stored in a suitable hardware structure.

For the purposes of this specification, a machine-readable medium includes any mechanism that provides (i.e. stores and/or transmits) information in a form readable by a machine (e.g. computer) for example, a machine-readable medium includes read-only memory (ROM); random-access memory (RAM); magnetic disk storage media; optical storage media; flash memory devices; electrical, optical, acoustical or other form of propagated signals (e.g. carrier waves, infra red signals, digital signals, etc.); etc.

It will be apparent from this description the aspects of the present invention may be embodied, at least partly, in software. In other embodiments, hardware circuitry may be used in combination with software instructions to implement the present invention. Thus, the invention is not limited to any specific combination of hardware circuitry and software.

Although the present invention has been described with reference to specific exemplary embodiments, it will be evident that various modification and changes can be made to these embodiments without departing from the broader spirit of the invention as set forth in the claims. Accordingly, the specification and drawings are to be regarded in an illustrative sense rather than in a restrictive sense.

What is claimed is:

1. A method comprising:
monitoring an indicator indicating a usage of data speculatively loaded by a processor as a result of executing a speculative instruction; and
selectively executing said speculative instruction when it is next encountered at an instruction pointer based on said usage.

2. The method of claim 1, wherein said indicator comprises an execution of a further instruction which indicates whether said speculatively loaded data was used.

3. The method of claim 1, wherein said speculative instruction is selected from the group comprising a speculative-load instruction which loads data into a register of said processor; and a prefetch instruction which loads data from a random-access memory into a data cache of said processor.

4. The method of claim 3, wherein said further instruction in the case of said speculative instruction being a speculative-load instruction is selected from the group comprising a validation instruction associated with said speculative-load instruction, and a load instruction which loads new data into said register before a use of data speculatively loaded into said register as a result of executing said speculative-load instruction.

5. The method of claim 3, wherein said further instruction in the case of said speculative instruction being a prefetch instruction comprises a load instruction which causes data loaded into said data cache as a result of executing said prefetch instruction to be loaded into a register of said processor.

6. The method of claim 4, wherein said monitoring comprises creating a mapping between each said speculative-load instruction and each said validation instruction.

7. The method of claim 5, wherein said monitoring comprises creating a mapping between each said prefetch instruction and each said load instruction.

8. The method of claim 6, wherein said mapping is created by a compiler.

9. The method of claim 8 further comprising loading said mapping into said processor.

10. The method of claim 9, wherein said monitoring further comprises checking whether said further instruction is executed for each speculative instruction in said mapping; and storing a history of execution of said further instruction.

11. The method of claim 10, further comprising making a prediction based on said history as to whether data speculatively loaded as a result of executing each speculative instruction in said mapping is likely to be used, and associating said prediction with each said speculative instruction.

12. The method of claim 11, wherein selectively executing said speculative instruction comprises not executing said speculative instruction when its associated prediction indicates that data to be loaded as a result of executing said speculative instruction is not likely to be used.

13. The method of claim 10, further comprising using said history to improve branch prediction.

14. A processor comprising:
a monitoring mechanism to monitor an indicator indicating a usage of data speculatively loaded by a processor as a result of executing a speculative instruction; and
a speculation control mechanism to selectively execute said speculative instruction when it is next encountered at an instruction pointer based on said usage.

15. The processor of claim 14, wherein said indicator comprises an execution of a further instruction which indicates whether said speculatively loaded data was used.

16. The processor of claim 14, wherein said speculative instruction is selected from the group comprising a speculative-load instruction which loads data into a register of said processor; and a prefetch instruction which loads data from a random-access memory into a data cache of said processor.

17. The processor of claim 16, wherein said further instruction in the case of said speculative instruction being a speculative-load instruction is selected from the group comprising a validation instruction associated with said speculative-load instruction; and a load instruction which loads new data into said register before a use of data speculatively loaded into said register as a result of executing said speculative-load instruction.

18. The processor of claim 16, wherein said further instruction in the case of said speculative instruction being a prefetch instruction comprises a load instruction which causes data loaded into said data cache as a result of executing said prefetch instruction to be loaded into a register of said processor.

19. The processor of claim 17, wherein said monitoring mechanism comprises a mapping between each said speculative-load instruction and each said validation instruction.

20. The processor of claim 18, wherein said monitoring mechanism comprises a mapping between each said prefetch instruction and each said load instruction.

21. The processor of claim 19, wherein said mapping is compiler generated and is loaded into said processor at runtime.

22. The processor of claim 21, wherein said monitoring mechanism checks whether said further instruction is executed for each speculative instruction in said mapping; and stores a history of execution of said further instruction.

23. The processor of claim 22, wherein said monitoring mechanism makes a prediction based on said history as to whether data speculatively loaded as a result of executing each speculative instruction in said mapping is likely to be used; and associates said prediction with each said speculative instruction.

24. The processor of claim 23, wherein said speculation control mechanism checks the prediction associated with each speculative instruction and executes said speculative instruction only if a prediction indicates that data to be loaded as a result of executing said speculative instruction is likely to be used.

25. A computer-readable medium having stored thereon a sequence of instructions which when executed by a processor cause said processor to perform a method comprising:
monitoring an indicator indicating a usage of data speculatively loaded by a processor as a result of executing a speculative instruction; and selectively executing said speculative instruction when it is next encountered at an instruction pointer based on said usage.

26. The computer-readable medium of claim 25 wherein said indicator comprises an execution of a further instruction which indicates whether said speculatively loaded data was used.

27. The computer-readable medium of claim 26 wherein said speculative instruction is selected from the group comprising a speculative-load instruction which loads data into a register of said processor; and a prefetch instruction which loads data from a random-access memory into a data cache of said processor.

28. The computer-readable medium of claim 27, wherein said further instruction in the case of said speculative instruction being a speculative-load instruction is selected from the group comprising a validation instruction associated with said speculative-load instruction; and a load instruction which loads new data into said register before a use of data speculatively loaded into said register as a result of executing said speculative-load instruction.

29. The computer-readable medium of claim 27, wherein said further instruction in the case of said speculative instruction being a prefetch instruction comprises a load instruction which causes data loaded into said processor as a result of executing said prefetch instruction to be loaded into a register of said processor.

30. A processor comprising:
means for monitoring an indicator indicating a usage of data speculatively loaded by a processor as a result of executing a speculative instruction; and
means for selectively executing said speculative instruction when it is next encountered at an instruction pointer based on said usage.

31. The processor of claim 30, wherein said indicator comprises an execution of a further instruction which indicates whether said speculatively loaded data was used.

32. The processor of claim 31, wherein said speculative instruction is selected from the group comprising a speculative-load instruction which loads data into a register of said processor; and a prefetch instruction which loads data from a random-access memory into a data cache of said processor.

33. The processor of claim 31, wherein said further instruction in the case of said speculative instruction being a speculative-load instruction is selected from the group comprising a validation instruction associated with said speculative-load instruction; and a load instruction which loads new data into said register before a use of data speculatively loaded into said register as a result of executing said speculative-load instruction.

34. The processor of claim 31, wherein said further instruction in the case of said speculative instruction being a prefetch instruction comprises a load instruction which causes data loaded into said data cache as a result of executing said prefetch instruction to be loaded into a register of said processor.

35. The processor of claim 31, wherein said means for monitoring comprises a mapping between each said speculative-load instruction and each said validation instruction.

36. The processor of claim 34, wherein said means for monitoring comprises a mapping between each said prefetch instruction and each said load instruction.

37. The processor of claim 35, wherein said mapping is compiler generated and is loaded into said processor at runtime.

38. The processor of claim 35, wherein said mapping is speculatively generated by hardware and is dynamically updated at runtime.

39. The processor of claim 37, wherein said means for monitoring checks whether said further instruction is executed for each speculative instruction in said mapping; and stores a history of execution of said further instruction.

40. The processor of claim 39, wherein said means for monitoring makes a prediction based on said history as to whether data speculatively loaded as a result of executing each speculative instruction in said mapping is likely to be used; and associates said prediction with each said speculative instruction.

41. The processor of claim 40, wherein said means for monitoring checks the prediction associated with each speculative instruction and executes said speculative instruction only if a prediction indicates that data to be loaded as a result of executing said speculative instruction is likely to be used.

42. A system comprising:
a memory, and
a processor coupled to the memory, the processor comprising
a monitoring mechanism to monitor an indicator indicating a usage of data speculatively loaded by a processor as a result of executing a speculative instruction; and
a speculation control mechanism to selectively execute said speculative instruction when it is next encountered at an instruction pointer based on said usage.

43. The system of claim 42, wherein said indicator comprises an execution of a further instruction which indicates whether said speculatively loaded data was used.
